(19) United States
(12) Patent Application Publication
(10) Pub. No.: US 2016/0168361 A1
(43) Pub. Date: Jun. 16, 2016

(54) TIRE TREAD

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Nathalie COSTE, Clermont-Ferrand (FR); Guillaume LEMASSON, Clermont-Ferrand (FR); Regis SCHACH, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(21) Appl. No.: 14/904,828

(22) PCT Filed: Jul. 8, 2014
(86) PCT No.: PCT/EP2014/064621

§ 371 Date: Jan. 13, 2016

(30) Foreign Application Priority Data
Jul. 15, 2013 (FR) 1356921

(51) Int. Cl. C08K 13/02

(52) U.S. Cl. CPC C08K 13/02

(57) ABSTRACT

A tire tread that comprises a rubber composition based on an elastomer matrix that comprises more than 50% by weight of at least one butyl rubber, on a reinforcing filler and on a plasticizing system that comprises at least one phosphoric acid ester having a glass transition temperature below −75° C. A tire comprising such a tread has both a low rolling resistance and a strong grip on wet ground.

This application is a 371 national phase entry of PCT/EP2014/064621, filed 8 Jul. 2014, which claims benefit of French Patent Application No. 1356921, filed 15 Jul. 2013, the entire contents of which are incorporated herein by reference for all purposes.

### BACKGROUND

1. Field

The present disclosure relates to tire treads comprising rubber compositions based on butyl rubber.

2. Description of Related Art

One of the requirements needed for a tire is to provide optimal grip on the road, especially on wet ground. One way of giving the tire increased grip on wet ground is to use a rubber composition in its tread, which composition has a broad hysteresis potential.

But at the same time, the tire tread must also minimize its contribution to the rolling resistance of the tire, that is to say have the lowest possible hysteresis. Thus, the rubber composition of the tread must satisfy two conflicting requirements, namely having a maximum hysteresis potential in order to satisfy the requirement of grip and having a hysteresis that is as low as possible in order to satisfy the requirement of rolling resistance.

Tire manufacturers have therefore proposed hysteretic materials, such as for example compositions based on copolymers of butadiene and styrene with a styrene weight content of at least 35%, rubber compositions comprising high contents of reinforcing fillers or plasticizers. But these solutions are generally obtained to the detriment of the rolling resistance.

It has also been proposed to introduce butyl rubber into the rubber compositions of the tire treads in order to improve their grip on wet ground. This is because butyl rubber is an elastomer whose dissipation potential is known and constitutes per se a good candidate for improving the grip, especially on wet ground, as patent U.S. Pat. No. 6,060,552 teaches. However, this patent also teaches that butyl rubber must be used at contents of at most 30 parts per hundred parts of elastomer (phr) in order to minimize its hysteretic contribution in the field of rolling resistance.

Patent EP 1 687 370 B1 discloses that the use, in a tire tread, of a rubber composition reinforced with a silica and comprising a certain content of butyl rubber and of glycerol trioleate makes it possible to improve the grip of the tire on wet ground. But this solution is not satisfactory with respect to the rolling resistance performance.

Satisfying both the requirement of grip, especially on wet ground, and of rolling resistance remains a constant concern of tire manufacturers.

### SUMMARY

The Applicant companies have discovered during their research that the combined presence, in the rubber composition, of a butyl rubber as predominant elastomer and of a specific phosphoric acid ester as plasticizer made it possible to improve the compromise between the wet grip performance and the rolling resistance performance of tire treads based on butyl rubber.

A first subject of the invention relates to a tire tread that comprises a rubber composition based on an elastomer matrix that comprises more than 50% by weight of at least one butyl rubber, on a reinforcing filler and on a plasticizing system that comprises at least one phosphoric acid ester having a glass transition temperature below −75° C.

Another subject of the invention is a tire comprising a tread in accordance with the invention.

A further subject of the invention is a process for preparing a tire tread in accordance with the invention.

Another subject of the invention is a rubber composition that can be used in a tread and is defined as above with the distinctive feature that the reinforcing filler consists predominantly by weight of a reinforcing inorganic filler, which composition additionally comprises a coupling agent.

A further subject of the invention is a process for preparing a rubber composition that can be used in a tread and is defined as above with the distinctive feature that the reinforcing filler consists predominantly by weight of a reinforcing inorganic filler, which composition additionally comprises a coupling agent.

### DETAILED DESCRIPTION OF THE SPECIFIC EMBODIMENTS

Any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

The expression “composition based on” should be understood as meaning a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

All the percentages are percentages by mass unless otherwise indicated.

One essential feature of the elastomer matrix of the rubber composition of the tread in accordance with an embodiment of the invention is to comprise at least one butyl rubber, that is to say one or more butyl rubbers.

Butyl rubbers are well known to a person skilled in the art, especially for their property of impermeability to air. They are copolymers of isobutylene and a C₄ to C₆ diene, especially isoprene. Generally, these copolymers contain 1 to 5 mol % of diene units, especially isoprene units, and have a Mooney viscosity (ML 1+8 at 125° C.) of from 30 to 60.

The at least one butyl rubber may be a halogenated butyl rubber.

Halogenated butyl rubber refers to the halogenated copolymers of isobutylene and a C₄ to C₆ diene, especially isoprene. They are obtained by halogenation, especially by chlorination or bromination, of the copolymers of isobutylene and a C₄ to C₆ diene, especially isoprene. The halogenated copolymers of isobutylene and a C₄to C₆ diene, especially isoprene, generally have a halogen content of 1 to 4% by weight of the weight of copolymer. The halogenated butyl rubber is preferably a brominated butyl rubber.

By extension of the definition of butyl rubber, the at least one butyl rubber may also be a terpolymer of isobutylene, para-methylstyrene and halogenated, preferably brominated, para-methylstyrene, sold under the name EXXPRO by EXXON or Polysar XL 10000 by Bayer.

The at least one butyl rubber is used at a content of greater than 50% by weight of the weight of the elastomer matrix of the rubber composition. At a content lower than the aforementioned content, the grip of the tread is insufficient. The higher the content of the at least one butyl rubber in the elastomer matrix of the rubber composition, the better the grip potential of the tread comprising the rubber composition. This content is preferably greater than 70%, more preferably greater than 80%, more preferably still greater than 90% by weight of the weight of the elastomer matrix of the rubber composition. Advantageously, this content is 100% by weight of the weight of the elastomer matrix of the rubber composition, that is to say the elastomer matrix consists of the at least one butyl rubber.

When the weight content of the at least one butyl rubber is less than 100% of the weight of the elastomer matrix, another essentially unsaturated diene elastomer or a mixture of essentially unsaturated diene elastomers is used to make the matrix up to 100%. The elastomer matrix then consists of the at least one butyl rubber and of essentially unsaturated diene elastomer.

“Essentially unsaturated” is understood to mean generally a diene elastomer resulting at least in part from conjugated diene monomers having a content of units of diene origin (conjugated dienes) which is greater than 15% (mol %). Polybutadienes, polyisoprenes including natural rubber, butadiene copolymers, isoprene copolymers and the mixtures of these elastomers are suitable as essentially unsaturated diene elastomer. Also suitable are the copolymers of conjugated diene monomers and vinylaromatic, in particular styrene, monomers.

The choice of the diene elastomer will be governed both by its glass transition temperature, Tg, and its weight content in the elastomer matrix, and also by the desired compromise between the grip on wet ground and the rolling resistance of the tire. If it is desired to improve more the rolling resistance performance, use is preferably made of a diene elastomer having a relatively low Tg, in particular below −25° C. If it is desired to improve more the grip on wet ground, use is preferably made of an elastomer having a Tg of at least −25° C. The improvement in the wet grip performance and in the rolling resistance performance increases with the content of the at least one butyl rubber in the elastomer matrix.

The rubber composition of the tread in accordance with an embodiment of the invention comprises any type of filler referred to as reinforcing, known for its abilities to reinforce a rubber composition which can be used for the manufacture of tires, for example a reinforcing organic filler, such as carbon black, a reinforcing inorganic filler, such as silica, or also a mixture of these two types of filler.

Such a reinforcing filler typically consists of nanoparticles, the (weight-)average size of which is less than a micrometre, generally less than 500 nm, usually between 20 and 200 nm, in particular and more preferably between 20 and 150 nm.

All carbon blacks, especially the blacks conventionally used in tire treads, are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks. These carbon blacks can be used in the isolated state, as available commercially, or in any other form, for example as support for some of the rubber additives used.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used can be any reinforcing silica known to a person skilled in the art, in particular any precipitated or fumed silica exhibiting a BET surface area and a CTAB specific surface area both of less than 450 m²/g.

Mention will also be made, as reinforcing inorganic filler, of mineral fillers of the aluminous type, in particular alumina (Al₂O₃) or aluminium (oxide)hydroxides, or else reinforcing titanium oxides, for example described in U.S. Pat. No. 6,610,261 and U.S. Pat. No. 6,747,087.

The physical state in which the reinforcing inorganic filler is present is not important, whether it is in the form of powder, micropearls, granules or else beads. Of course, the expression “reinforcing inorganic filler” is also understood to mean mixtures of various reinforcing inorganic fillers, in particular highly dispersible silicas as described above.

A person skilled in the art will understand that a reinforcing filler of another nature, in particular organic nature, such as carbon black, might be used as filler equivalent to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to establish the bonding between the filler and the elastomer. By way of example, mention may be made, for example, of carbon blacks for tires, as described, for example, in patent documents WO 96/37547 and WO 99/28380.

Preferably, the content of reinforcing filler is between 40 and 150 phr. Below 40 phr, the reinforcement of the rubber composition is insufficient to provide an adequate level of cohesion or wear resistance of the rubber composition. More preferably still, the content of reinforcing filler is at least 50 phr. Above 150 phr, there is a risk of increasing the hysteresis and therefore the rolling resistance of the tires. For this reason, the content of reinforcing filler is preferably within a range of from 50 to 120 phr.

According to one embodiment of the invention, the reinforcing filler comprises a reinforcing organic filler, preferably a carbon black.

According to another embodiment of the invention, the reinforcing filler comprises a reinforcing inorganic filler, preferably a silica.

According to one preferred embodiment of the invention, the reinforcing filler consists predominantly by weight of a reinforcing inorganic filler, which means that the reinforcing inorganic filler constitutes more than 50% by weight of the reinforcing filler of the rubber composition of the tread in accordance with the invention. This reinforcing inorganic filler is preferably a silica.

According to one particular embodiment where the reinforcing inorganic filler such as silica represents more than 50% by weight of the reinforcing filler, carbon black is used preferably at a content of less than 20 phr, more preferably less than 10 phr (for example between 0.5 and 20 phr, in particular between 2 and 10 phr), more preferably still less than 5 phr. In the ranges indicated, the colouring properties (black pigmenting agent) and UV-stabilizing properties of the carbon blacks are benefited from, without, moreover, adversely affecting the typical performances provided by the reinforcing inorganic filler.

In order to couple the reinforcing inorganic filler to at least one of the elastomers that constitute the elastomer matrix of the rubber composition, especially in the case where the inorganic filler constitutes more than 50% by weight of the reinforcing filler of the rubber composition, use is generally made, in a well known manner, of a coupling agent (or bonding agent). The expression “coupling agent” is understood more specifically to mean an agent capable of establishing a sufficient bond of chemical and/or physical nature between the filler in question and the elastomer, while facilitating the dispersion of this filler within the elastomer matrix.

This at least bifunctional agent is intended to ensure a sufficient connection, of chemical and/or physical nature, between the inorganic filler (surface of its particles) and the elastomer. Use is made, in particular, of organosilanes, especially alkoxysilane polysulphides or mercaptosilanes, or else polyorganosiloxanes bearing functions capable of bonding physically and/or chemically to the inorganic filler and functions capable of bonding physically and/or chemically to the elastomer, for example by means of a sulphur atom. Silica/elastomer bonding agents, in particular, have been described in a large number of documents, the best known being bifunctional alkoxysilanes such as alkoxysilane polysulphides. Use is made, in particular, of silane polysulphides, referred to as “symmetrical” or “asymmetrical” depending on their particular structure, as described for example in applications WO 03/002648 (or US 2005/016651) and WO 03/002649 (or US 2005/016650).

Mention will in particular be made, as coupling agent other than alkoxysilane polysulphide, of bifunctional POSs (polyorganosiloxanes), or else of hydroxysilane polysulphides as described in patent applications WO 02/30939 (or U.S. Pat. No. 6,774,255) and WO 02/31041 (or US 2004/051210), or else of silanes or POSs bearing azodicarbonyl functional groups, as described for example in patent applications WO 2006/125532, WO 2006/125533 and WO 2006/125534.

As examples of other silane sulphides, mention will be made, for example, of the silanes bearing at least one thiol (—SH) function (referred to as mercaptosilanes) and/or at least one blocked thiol function, as described for example in patents or patent applications U.S. Pat. No. 6,849,754, WO 99/09036, WO 2006/023815, WO 2007/098080, WO 2010/072685 and WO 2008/055986.

According to the particular embodiment of the invention where a halogenated butyl rubber is used, the coupling agent is preferably an aminoalkylalkoxysilane. The term “aminoalkylalkoxysilane” is understood to mean an alkylalkoxysilane in which the alkyl radical bears an amine group. The alkyl radical is preferably a C₁-C₆ radical, more preferably an ethyl or propyl radical. The alkoxy radical is preferably a C₁-C₆ radical, more preferably a C₁-C₃ radical, more preferably still a methoxy or ethoxy radical. The amine group is preferably NH₂.

Furthermore, the aminoalkylalkoxysilane is advantageously an aminoalkyltrialkoxysilane. As aminoalkyltrialkoxysilane, 3-aminopropyltrimethoxysilane and 3-aminopropyltriethoxysilane are very particularly suitable.

According to this particular embodiment of the invention, the aminoalkylalkoxysilane may also be used as a mixture with another coupling agent of different chemical structure. Preferably, this mixture contains an aminoalkylalkoxysilane and an alkoxysilane polysulphide, in particular a mixture of 3-aminopropyltriethoxysilane and bis(3-triethoxysilylpropyl) tetrasulphide (TESPT).

The content of coupling agent, whether it is a single compound or a mixture of compounds, is advantageously less than 20 phr, it being understood that it is generally desirable to use the least possible thereof. Typically, the content of coupling agent represents from 0.5% to 15% by weight, with respect to the amount of inorganic filler. Its content is preferably between 0.5 and 12 phr, more preferably within a range of from 3 to 10 phr. This content is easily adjusted by a person skilled in the art depending on the content of inorganic filler used in the composition.

Alternatively, the coupling agent may be provided by the silica, the surface of which has been modified beforehand by an organosilane, such as bis(3-triethoxysilylpropyl) tetrasulphide or mercaptosilanes. Such silicas are sold by Evonik and PPG under the respective names “Coupsil” and “Ciptane”.

The rubber composition of the tread in accordance with an embodiment of the invention may also contain coupling activators, agents for covering the inorganic fillers or more generally processing aids capable, in a known manner, by virtue of an improvement in the dispersion of the filler in the rubber matrix and of a lowering of the viscosity of the rubber composition, of improving its ease of processing in the uncured state, these agents being, for example, hydrolysable silanes, such as alkylalkoxysilanes, polyols, polyethers, primary, secondary or tertiary amines, or hydroxylated or hydrolysable polyorganosiloxanes.

The at least one phosphoric acid ester has a glass transition temperature below −75° C., preferably below −85° C. and more preferably below −95° C. Phosphoric acid triesters are very particularly suitable as phosphoric acid ester. In particular, mention may be made of the triesters (R₁O)(R₂O)(R₃O)P(O) where R₁, R₂ and R₃ are independently identical or different and each represent an aliphatic or aromatic group, preferably an aliphatic group, more preferably a hydrocarbon-based aliphatic group. Preferably, the R₁, R₂ and R₃ groups comprise at least 4 carbon atoms, more preferably 4 to 20 carbon atoms. By way of example, tributyl phosphate, trihexyl phosphate, tris(2-ethylhexyl) phosphate, trinonyl phosphate, tridecyl phosphate and trioleyl phosphate are suitable. Tris(2-ethylhexyl) phosphate, also commonly known as trioctyl phosphate, is very particularly preferred.

The content of the at least one phosphoric acid ester in the rubber composition typically varies within a range extending from 10 to 80 phr, more preferably from 15 to 60 phr, more preferably still from 20 to 40 phr.

When tris(2-ethylhexyl) phosphate is used, it is introduced into the rubber composition in a preferential content ranging from 10 to 80 phr, more preferably from 15 to 60 phr, more preferably still from 20 to 40 phr.

The content of the at least one phosphoric acid ester is adjusted depending on its Tg and depending on the content of butyl rubber in the elastomer matrix. For example, the higher the Tg of the at least one phosphoric acid ester, the larger the content thereof in the rubber composition.

In the case where the at least one ester consists of a mixture of esters, the content of the at least one ester applies to the mixture of esters.

According to one particularly preferred embodiment, the at least one ester constitutes the only plasticizer of the rubber composition, that is to say that the plasticizing system consists of the at least one ester. In the case where the plasticizing system consists of a mixture of esters according to an embodiment of the invention, the composition contains no plasticizers other than this mixture of esters.

According to another embodiment of the invention, the plasticizing system of the rubber composition may contain another plasticizer in addition to the at least one ester. This other plasticizer may itself have a glass transition temperature below −75° C. Alternatively, this other plasticizer may have a glass transition temperature above or equal to −75° C., such as for example the oils conventionally used in the rubber compositions, such as paraffinic, aromatic and naphthenic oils. This other plasticizer is used at a content preferably of between 0 and 30 phr, more preferably of between 0 and 15 phr.

According to one very particularly preferred embodiment that makes it possible to optimize even more the compromise between the rolling resistance performance and the wet grip performance, the mass content of the plasticizing system P expressed relative to the mass of the at least one butyl rubber and the glass transition temperature Tgₚ of the plasticizing system expressed in kelvin satisfy the following equation:

P×(208−Tgₚ)±Tgₚ≧0.025

The mass content of the plasticizing system P expressed relative to the mass of the at least one butyl rubber is defined by the ratio of the mass of the plasticizing system to the sum of the mass of the plasticizing system and the mass of the at least one butyl rubber.

The rubber composition of the tread in accordance with the invention may also comprise all or some of the usual additives customarily used in rubber compositions intended for the manufacture of tires, such as, for example, pigments, protective agents, such as antiozone waxes, chemical antiozonants, antioxidants, antifatigue agents, a crosslinking system based either on sulphur or on sulphur donors and/or on peroxide and/or on bismaleimides, vulcanization accelerators, vulcanization activators and mixtures of such compounds.

The rubber composition of the tread in accordance with an embodiment of the invention may be manufactured in appropriate mixers, generally using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) up to a lower temperature, typically below 110° C., for example between 40° C. and 100° C., during which finishing phase the crosslinking system is incorporated.

The rubber composition of the tread in accordance with the invention may be prepared according to a process that comprises the following steps:
thermomechanically kneading the elastomer matrix that comprises more than 50% by weight of the at least one butyl rubber, the reinforcing filler and the plasticizing system, where appropriate the coupling agent and the other additives of the rubber composition with the exception of the crosslinking system, until a maximum temperature of between 110° C. and 190° C. is reached;
cooling the combined mixture to a temperature below 100° C.;
subsequently incorporating a crosslinking system;
kneading everything up to a maximum temperature below 110° C. in order to obtain a rubber composition.

The tread in accordance with an embodiment of the invention may be manufactured according to the process described above which comprises an additional step of calendering or extruding the rubber composition.

The invention, in an embodiment, relates to the tread described above, both in the uncured state (that is to say, before curing) and in the cured state (that is to say, after crosslinking or vulcanization). The invention also relates, in an embodiment, to the tire comprising a tread in accordance with an embodiment of the invention, which tire is both in the uncured state and in the cured state.

The crosslinking (or curing), where appropriate the vulcanization, is carried out in a known manner at a temperature generally of between 130° C. and 200° C., for a sufficient time which may vary, for example, between 5 and 90 min, depending in particular on the curing temperature, on the crosslinking system adopted and on the crosslinking kinetics of the composition in question.

The invention also relates, in an embodiment, to a rubber composition which has any one of the features of the rubber composition of the tread in accordance with an embodiment of the invention. This rubber composition, a particular subject of the invention, also has the essential feature of comprising an inorganic filler, preferably a silica, which constitutes more than 50% by weight of the reinforcing filler of the rubber composition. It also has the essential feature of comprising a coupling agent as defined above for bonding the inorganic filler, in particular silica, to the elastomer of the rubber composition.

The rubber composition, a particular subject of the invention, may be prepared according to a process that comprises the following steps:
thermomechanically kneading the elastomer matrix that comprises more than 50% by weight of the at least one butyl rubber, the reinforcing filler, the coupling agent and the plasticizing system until a maximum temperature of between 110° C. and 190° C. is reached;
cooling the combined mixture to a temperature below 100° C.;
subsequently incorporating a crosslinking system;
kneading everything up to a maximum temperature below 110° C. in order to obtain a rubber composition.

The aforementioned features of the present invention, as well as others, will be better understood on reading the following description of several exemplary embodiments of the invention, given by way of non-limiting illustration.

### EXEMPLARY EMBODIMENTS OF THE INVENTION

### Example 1

The glass transition temperature is measured by means of a differential calorimeter (differential scanning calorimeter) according to the standard ASTM D3418 (1999). In the case of a mixture of plasticizers, the measurement is carried out on the mixture of plasticizers in the relative proportions of those of the rubber composition of the tread in accordance with an embodiment of the invention.

The dynamic properties are measured on a viscosity analyser (Metravib VA4000) according to the standard ASTM D 5992−96. The response of a sample of vulcanized composition (cylindrical test specimen with a thickness of 2 mm and a cross section of 79 mm²), subjected to a simple alternating sinusoidal shear stress, at a frequency of 10 Hz, under standard temperature conditions (23° C.) according to the standard ASTM D 1349-09, is recorded. A peak-to-peak strain amplitude sweep is carried out from 0.1% to 50% (forward cycle) and then from 50% to 0.1% (return cycle). The result evaluated is the loss factor tanδ. For the return cycle, the maximum value of tanδ observed (tanδₘₐₓ) is indicated.

The loss factor at 23° C. is expressed relative to a base 100. Since the control has an index of 100, a value above 100 indicates an improved result: the composition of the example in question has a lower hysteresis at 23° C., expressing a lower rolling resistance of the tread comprising such a composition.

On the same equipment, the response of a sample of vulcanized composition (cylindrical test specimen with a thickness of 2 mm and a cross section of 79 mm²) to a given stress, at a frequency of 10 Hz, under variable temperature conditions, is recorded. The result evaluated is the loss factor tan (δ) at −20° C. The loss factor is expressed relative to a base 100 with respect to the loss factor of the control composition. A value above 100 demonstrates an improved result with a higher hysteresis of the composition considered, at −20° C., expressing a better grip on wet ground of the tread comprising such a composition.

### Preparation of the Rubber Compositions C0 and C1:

The formulations (in phr) of the compositions C0 and C1 are described in Table I. Composition C1 contains 100 phr of a brominated butyl rubber and 25 phr of tris(2-ethylhexyl) phosphate having a Tg of −114° C.

Composition C1 is in accordance with the invention.

Composition C0 which is not in accordance with the invention contains no plasticizer. It contains 100 phr of a brominated butyl rubber, 74 phr of silica and 5 phr of carbon black as reinforcing filler, which corresponds to a volume fraction of reinforcing filler of 25%. This volume fraction of reinforcing filler is identical to that of C1.

For each of the compositions, the silane content and the diphenylguanidine content were adjusted as a function of the silica content present in the rubber composition.

In summary, composition C1 differs from C0 in that it contains a plasticizer in accordance with the invention.

TABLE I

| | C0 not in | C1 in |
|---|---|---|
| | accordance | accordance |
| BIIR (1) | 100 | 100 |
| Silica (2) | 74 | 90 |
| Silane (3) | 4.8 | 6.0 |
| Carbon black N234 | 5 | 5 |
| Plasticizer (4) | 0 | 25 |
| ZnO | 2.5 | 2.5 |
| Stearic acid | 2.0 | 2.0 |
| Antioxidant (5) | 1.9 | 1.9 |
| Ozone wax | 1.5 | 1.5 |
| DPG (6) | 1.5 | 1.7 |
| Sulphenamide | 1.5 | 1.5 |
| Sulphur | 2 | 2 |
| Volume fraction of filler | 25% | 25% |
| Properties in the cured state | | |
| tan δₘₐₓ 23° C. | 100 | 131 |
| tan δₘₐₓ −20° C. | 100 | 136 |

(1) BIIR 3220 brominated butyl rubber from Lanxess
(2) Zeosil 1165 MP silica from Rhodia (HDS type)
(3) Aminopropyltriethoxysilane
(4) Tris(2-ethylhexyl) phosphate
(5) N-(1,3-dimethylbutyl)-N′-phenyl-p-phenylenediamine, from Flexsys
(6) Diphenylguanidine (Perkacit DPG from Flexsys)

These compositions are manufactured in the following manner: the elastomer, the silica, the coupling agent, where appropriate the plasticizer, and also the various other ingredients, with the exception of the vulcanization system, are successively introduced into an internal mixer (final degree of filling: around 70% by volume), the initial vessel temperature of which is around 60° C. Thermomechanical working (non-productive phase) is then carried out in one step, which lasts in total 5 min, until a maximum “dropping” temperature of 165° C. is reached. The mixture thus obtained is recovered and cooled and then sulphur and an accelerator of sulphenamide type are incorporated on a mixer (homofinisher) at 23° C., everything being mixed (productive phase) for an appropriate time (for example between 5 and 12 min).

The properties of compositions C0 and C1 after curing appear in Table I.

It is observed that composition C1 has both much lower hysteresis at 23° C. and higher hysteresis at −20° C. than the control composition C0. These results show that introducing an ester in accordance with the invention into a butyl rubber composition enables a gain both in rolling resistance and in grip on wet ground for a tire comprising a tread based on butyl rubber. The compromise between the wet grip performance and the low rolling resistance performance of a tread based on butyl rubber is improved.

### Example 2

A rubber composition C2, the formulation of which (in phr) is recorded in Table II, was prepared in the same way as compositions C0 and C1. Composition C2 contains 100 phr of a brominated butyl rubber and 25 phr of tris(2-ethylhexyl) phosphate ester. In accordance with the invention, it is used as tread of a radial carcass passenger vehicle tire, denoted by P-C2, of 205/55R16 size that is conventionally manufactured.

Except for the constituent rubber composition of the tread, the P-C2 tire is in all respects identical to a “Primacy HP” reference tire, used as a reference as regards grip on wet ground. The performance of the P-C2 tire is compared to that of the “Primacy HP” reference tire relative to a base 100. The results appear in Table II.

For the tire tests, all the tires are fitted to the front and rear of a motor vehicle, under nominal inflation pressure.

The tires fitted to a motor vehicle of Renault make and “Mégane” model, equipped with an ABS system, are subjected to braking tests on wet ground at 25° C. that consist in measuring the distance needed to go from 80 km/h to 10 km/h during sudden braking on sprayed ground (bituminous concrete). A value greater than that of the control, arbitrarily set at 100, indicates an improved result, that is to say a shorter braking distance.

The rolling resistance is measured on a flywheel, according to the ISO 87−67 (1992) method. A value greater than that of the control, set at 100, indicates an improved result, that is to say a lower rolling resistance.

TABLE II

| | C2 |
|---|---|
| BIIR (1) | 100 |
| Silica (2) | 90 |
| Silane (3) | 6.6 |
| Carbon black N234 | 5 |
| Plasticizer (4) | 25 |
| ZnO | 2.5 |
| Stearic acid | 2.0 |
| Antioxidant (5) | 1.9 |
| Ozone wax | 1.5 |
| DPG (6) | 1.7 |
| Sulphenamide | 1.5 |
| Sulphur | 2 |
| Volume fraction of filler | 25% |
| Tire properties | P-C2 |
| Rolling resistance | 104 |
| Grip on wet ground | 139 |

(1) BIIR 3220 brominated butyl rubber from Lanxess
(2) Zeosil 1165 MP silica from Rhodia (HDS type)
(3) Mixture of 3 phr of aminopropyltriethoxysilane and 3.6 phr of TESPT
(4) Tris(2-ethylhexyl) phosphate
(5) N-(1,3-dimethylbutyl)-N′-phenyl-p-phenylenediamine, from Flexsys
(6) Diphenylguanidine (Perkacit DPG from Flexsys)

It is observed that the P-C2 tire has a greatly improved wet grip performance relative to that of the reference tire, and this without being to the detriment of the rolling resistance. On the contrary, an improvement in the rolling resistance is even observed.

These tire tests corroborate the results from Example 1 that demonstrated the potential of the rubber compositions in accordance with the invention as tread material having low rolling resistance and strong grip on wet ground.

1. A tire tread that comprises a rubber composition based:
on an elastomer matrix that comprises more than 50% by weight of at least one butyl rubber,
on a reinforcing filler,
and on a plasticizing system that comprises at least one phosphoric acid ester having a glass transition temperature below −75° C.

2. The tread according to claim 1, wherein the at least one ester has a glass transition temperature below −85° C.

3. The tread according to claim 1, wherein the at least one butyl rubber represents more than 70 by weight of the elastomer matrix.

4. The tread according to claim 3, wherein the at least one butyl rubber represents 100% by weight of the elastomer matrix.

5. The tread according to claim 1, wherein the at least one butyl rubber is a copolymer of isobutylene and a C₄ to C₆ diene.

6. The tread according to claim 5, wherein the at least one butyl rubber is a halogenated butyl rubber.

7. The tread according to claim 1, wherein the at least one butyl rubber is a terpolymer of isobutylene, para-methylstyrene and halogenated para-methylstyrene.

8. The tread according to claim 1, wherein the content of the at least one ester varies within a range extending from 10 to 80 phr.

9. The tread according to claim 1, wherein the at least one ester is a triester.

10. The tread according to claim 9, wherein the triester corresponds to the formula (R₁O)(R₂O)(R₃O)P(O) where R₁, R₂ and R₃ are independently identical or different and each represent an aliphatic or aromatic group.

11. The tread according to claim 10, wherein the at least one ester is tris(2-ethylhexyl) phosphate.

12. The tread according to claim 1, wherein the plasticizing system comprises between 0 and 30 phr.

13. The tread according to claim 1, wherein the plasticizing system consists of the at least one ester.

14. The tread according to claim 1, wherein the mass content of the plasticizing system P expressed relative to the mass of the at least one butyl rubber and the glass transition temperature Tgₚ of the plasticizing system expressed in kelvin satisfy the following equation:
P×(208−Tgₚ)±Tgₚ≧0.025

15. The tread according to claim 1, wherein the content of reinforcing filler is between 40 and 150 phr.

16. The tread according to claim 1, wherein the reinforcing filler comprises a reinforcing organic filler.

17. The tread according to claim 1, wherein the reinforcing filler comprises a reinforcing inorganic filler.

18. The tread according to claim 17, wherein the composition further comprises a coupling agent.

19. The tread according to claim 18, wherein the at least one butyl rubber is a halogenated butyl rubber and the coupling agent is an aminoalkylalkoxysilane or a mixture of aminoalkylalkoxysilane and alkylalkoxysilane polysulphide.

20. The tread according to claim 18, wherein the reinforcing inorganic filler represents more than 50% by weight of the reinforcing filler.

21. The tread according to claim 20, wherein the content of carbon black in the rubber composition is less than 20 phr.

22. A process for preparing a tire tread according to claim 1, which process comprises:
thermomechanically kneading the elastomer matrix that comprises more than 50% by weight of the at least one butyl rubber, the reinforcing filler and the plasticizing system until a maximum temperature of between 110° C. and 190° C. is reached;
cooling the combined mixture to a temperature below 100° C.;
subsequently incorporating a crosslinking system;
kneading everything up to a maximum temperature below 110° C. in order to obtain a rubber composition;
extruding or calendering the rubber composition thus obtained.

23. Tire comprising a tread according to claim 1.

24. A rubber composition as defined in claim 20.

25. A process for manufacturing the rubber composition according to claim 24, which process comprises:
thermomechanically kneading the elastomer matrix that comprises more than 50% by weight of the at least one butyl rubber, the reinforcing filler, the coupling agent and the plasticizing system until a maximum temperature of between 110° C. and 190° C. is reached;
cooling the combined mixture to a temperature below 100° C.;
subsequently incorporating a crosslinking system;
kneading everything up to a maximum temperature below 110° C. in order to obtain a rubber composition.
